(19) United States
(12) Patent Application Publication
(10) Pub. No.: US 2016/0196188 A1
(43) Pub. Date: Jul. 7, 2016

(54) FAILURE RECOVERY OF A TASK STATE IN BATCH-BASED STREAM PROCESSING

(71) Applicant: Hewlett Packard Enterprise Development, LP, Houston, TX (US)

(72) Inventors: Maria G CASTELLANOS, Sunnyvale, CA (US); Qiming CHEN, Sunnyvale, CA (US); Meichun HSU, Los Altos Hills, CA (US)

(21) Appl. No.: 14/916,330

(22) PCT Filed: Sep. 13, 2013
(86) PCT No.: PCT/US2013/059588

§ 371 Date: Mar. 3, 2016

(51) Int. Cl. G06F 11/14

(52) U.S. Cl. CPC G06F 11/1469; G06F 11/1451; G06F 2201/805; G06F 2201/84

(57) ABSTRACT

Described herein are techniques for failure recovery of a task state in batch-based stream processing. A message including a batch of tuples can be unpacked into component tuples. The component tuples can be processed at a task node. A failure-recovery checkpoint of a state of the task node can be generated before all of the component tuples have been processed.

### BACKGROUND

Stream processing can be used in continuous dataflow environments to process a stream. A stream is an unbounded sequence of data elements (e.g., events), referred to herein as “tuples”. In stream processing, one or more operations may be applied to an input stream, tuple by tuple, so as to generate a new output stream of output tuples.

In a distributed stream processing system, a single logical operation may in fact have multiple instances running in parallel. Each instance of an operation is referred to as a “task”. The multiple tasks may be distributed over multiple server nodes. The multiple tasks and flow of the tuples can be represented and managed as a graph-structured streaming process. If one of the server nodes running a task (referred to herein as a “task node”) fails, failure recovery may be performed to maintain the integrity of the entire graph-structured streaming process.

### BRIEF DESCRIPTION OF DRAWINGS

The following detailed description refers to the drawings, wherein:

FIG. 1 illustrates a method of generating a failure-recovery checkpoint in a batch-based streaming process, according to an example.

FIG. 2 illustrates a method of generating mini-batches to facilitate intra-batch checkpointing, according to an example.

FIG. 3 illustrates a method of recovering from a failure, according to an example.

FIG. 4 illustrates a method of recovering from a failure, according to an example.

FIG. 5 illustrates a computing system for failure recovery in batch-based stream processing, according to an example.

FIG. 6 illustrates a computer-readable medium for failure recovery in batch-based stream processing, according to an example.

### DETAILED DESCRIPTION

The disclosed techniques address an issue in failure recovery in batch-based stream processing. In a distributed streaming process, the parallel and distributed tasks are chained in a graph-structure, with each task transforming an input stream to a new stream as output. Source tasks send their output (i.e., the output stream containing transformed tuples) to target tasks via messages. However, data transfer between tasks can often become a significant performance overhead in a stream processing system. Accordingly, multiple individual tuples can be packed into a single message payload. In this manner, a single message can include a batch of tuples, such as in the form of a fat-tuple. A fat-tuple is a tuple with key fields and a nested relation that depends on the key fields. This technique can significantly reduce the data communication overhead in the stream processing system, since the number of messages sent between tasks can be significantly reduced. As an example, 1000 tuples can be transferred in a single message as a fat-tuple. During data processing by a receiving task, the fat-tuple can be unpacked to multiple individual component tuples, which are then processed one by one by the task.

The transaction property of stream processing requires that input tuples be processed in the order of their generation in every dataflow path, with each tuple processed once and only once. If a task fails during stream processing, the task should be recovered in order to maintain the integrity of the streaming process. The failure recovery of a task allows the previously produced results to be corrected for eventual consistency of the overall streaming process. In transactional stream processing, typically every task checkpoints its execution state and output tuples. Then, when a task is restored from a failure, the last state of the task is recovered using the checkpoint, and the missing tuple (i.e., the tuple that the task was processing when it failed) is re-acquired and processed.

However, this can be inefficient for failure handling where the task was processing a fat-tuple. This is because the failure in processing an individual component tuple in a batch will eliminate the results of processing the entire fat-tuple (i.e., the results of processing all the previous component tuples in the given batch will be lost). For example, if the fat-tuple included 1000 tuples and the task node failed while processing the 950^{th} tuple, the results from processing the previous 949 tuples are lost. In order to address this deficiency, intra-batch failure-recovery checkpoints can be generated. For example, during processing of a fat-tuple, the computation results of mini-batches of individual component tuples contained in the fat-tuple can be checkpointed. Then, if a task node processing a fat-tuple fails, a recovered task node can begin processing of the fat-tuple at the most recent mini-batch checkpoint, rather than from the beginning.

In light of the above, according to an example, a technique implementing the principles described herein can include receiving a message comprising a batch of tuples (e.g., a fat-tuple) and unpacking the batch of tuples into multiple component tuples. The technique can further include processing, at a task node, a plurality of the component tuples, wherein the plurality of the component tuples is less than all of the component tuples. For example, the plurality of component tuples can represent a mini-batch of the batch of tuples. The method can further include generating a failure-recovery checkpoint of a state of the task node after processing the plurality of the component tuples. Additional failure-recovery checkpoints can be generated after processing each mini-batch of component tuples. If the task node fails during processing of the message, a task-recovery node can be initiated to a most recent checkpointed state of the failed task node based on the failure-recovery checkpoint. As a result, performance of the streaming process can be improved. Additional examples, advantages, features, modifications and the like are described below with reference to the drawings.

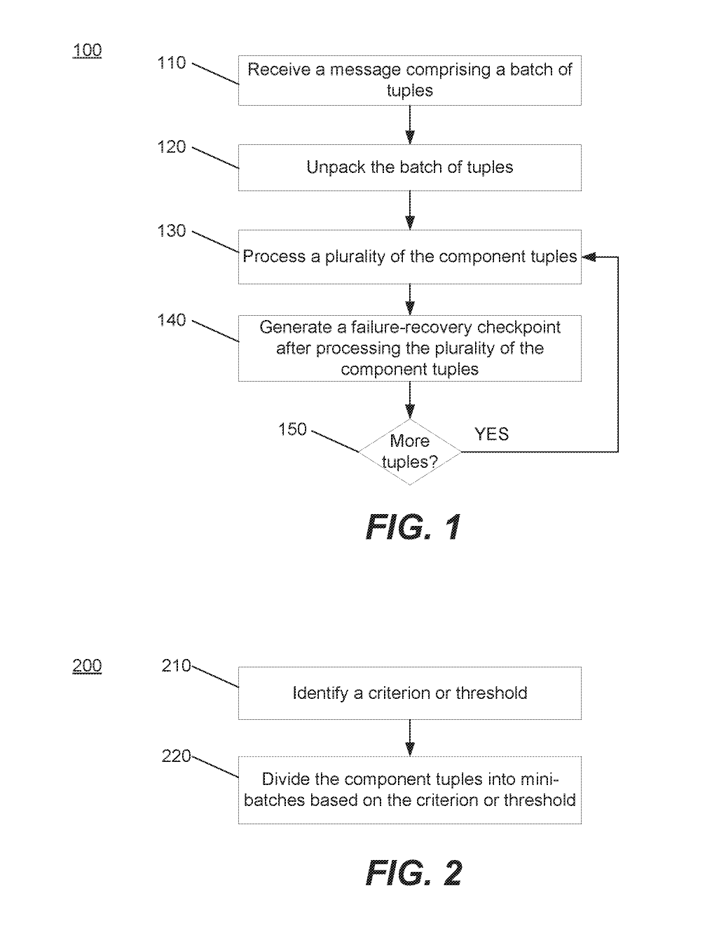

FIG. 1 illustrates a method for generating a failure-recovery checkpoint in a batch-based streaming process, according to an example. Method 100 may be performed by a computing device, system, or computer, such as processing system 500 or computing system 600. Computer-readable instructions for implementing method 100 may be stored on a computer readable storage medium. These instructions as stored on the medium are referred to herein as “modules” and may be executed by a computer.

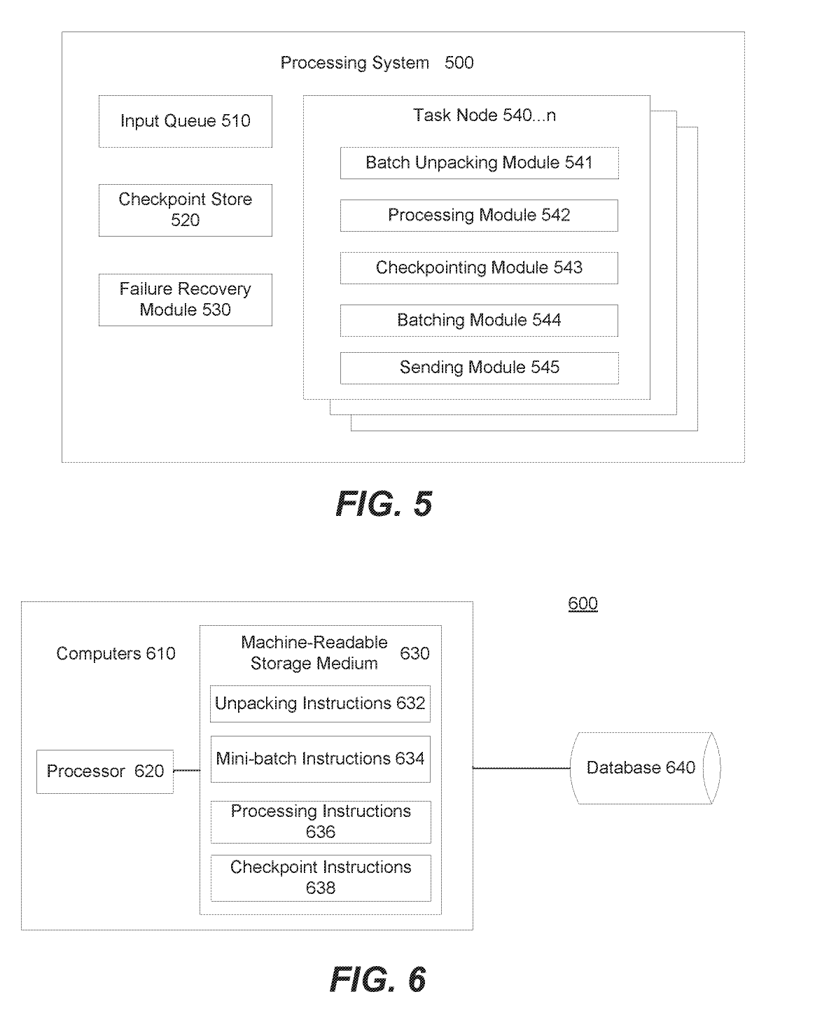

Methods 100-400 will be described here relative to example processing system 500 of FIG. 5. System 500 may include and/or be implemented by one or more computers. For example, the computers may be server computers, workstation computers, desktop computers, laptops, mobile devices, or the like, and may be part of a distributed system. In particular, system 500 may be part of a distributed stream processing system, such as one implementing the Storm architecture, which is an open source distributed real-time computation system. The computers may include one or more controllers and one or more machine-readable storage media.

A controller may include a processor and a memory for implementing machine readable instructions. The processor may include at least one central processing unit (CPU), at least one semiconductor-based microprocessor, at least one digital signal processor (DSP) such as a digital image processing unit, other hardware devices or processing elements suitable to retrieve and execute instructions stored in memory, or combinations thereof. The processor can include single or multiple cores on a chip, multiple cores across multiple chips, multiple cores across multiple devices, or combinations thereof. The processor may fetch, decode, and execute instructions from memory to perform various functions. As an alternative or in addition to retrieving and executing instructions, the processor may include at least one integrated circuit (IC), other control logic, other electronic circuits, or combinations thereof that include a number of electronic components for performing various tasks or functions.

The controller may include memory, such as a machine-readable storage medium. The machine-readable storage medium may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium can be computer-readable and non-transitory. Additionally, system 500 may include one or more machine-readable storage media separate from the one or more controllers.

Method 100 relates to a streaming process. A streaming process is a process that takes as input a stream (i.e., an unbounded sequence of data elements) and performs one or more operations on the stream. The streaming process may be represented in a graph-structure, and may be implemented by multiple tasks running on multiple computers. Task node 540 is an instance of an operation for the streaming process, implemented on a computer (e.g., a server computer, a server blade, etc.). Other task nodes may be implemented on other computers, and may be instances of the same operation or of different operations for the streaming process. A source task node relative to task node 540 is a task node that sends tuples to task node 540. A target task node relative to task node 540 is a task node that receives output tuples from task node 540. The tuples may be sent via messages between the task nodes. In transactional stream processing, in every dataflow path of the graph-structure, the tuples are to be processed in the order of their generation, with each processed once and only once (taking into account failure recovery of nodes).

Method 100 may begin at 110, where a message including a batch of tuples may be received. The message may be received at task node 540. The message may be received from another task node (i.e., a source task node), according to the graph-structure of the streaming process. The message may be initially received at an input queue 510 for the task node 540. Task node 540 may access the input queue 510 to obtain the message.

The message may include a batch of tuples. The batch of tuples may be arranged in the payload of the message as a fat-tuple. A fat-tuple includes key fields and a nested relation that depends on the key fields. This may be accomplished using the group-wise batch streaming mechanism. This mechanism exposes the key fields to the dataflow topology, is orthogonal to other task properties such as parallel- or window-based stream processing, and is transparent to users. Additional information on this batching technique can be found in PCT/US2013/034541, filed on Mar. 13, 2013 and entitled “Batching Tuples”, which is hereby incorporated by reference.

The message may be processed by the task node 540. For example, at 120, the batch of tuples may be unpacked into its multiple component tuples. For instance, if 1000 tuples were originally packed into the batch, after unpacking the batch would include 1000 component tuples ready for processing on an individual basis. During unpacking, the batch of tuples may be segregated into mini-batches.

Briefly turning to FIG. 2, method 200 is an example method for generating mini-batches to facilitate intra-batch checkpointing. At 210, a criterion or threshold may be identified for dividing the component tuples into mini-batches. The criterion or threshold may relate to various things. For example, an arbitrary number could be selected, say 100, and a mini-batch boundary could be created after every 100 component tuples. Thus, if the batch included 1000 component tuples, there would be 10 mini-batches of 100 tuples each. Alternatively, a certain number of mini-batches could be created irrespective of the number of component tuples. For instance, 5 (or 50, or 500, etc.) mini-batches could be created for each batch of tuples. Alternatively, the component tuples could be segregated based on some characteristic. For example, each component tuple may be associated with a time stamp. The component tuples could then be segregated into mini-batches based on time stamp. For instance, mini-batch boundaries could be created for each one-minute time period. Other techniques, criteria, or thresholds may be used as well. At 220, the component tuples may be divided into mini-batches based on the criterion or threshold.

Returning to FIG. 1, at 130 a plurality of the component tuples may be processed by processing module 542. For example, the plurality of component tuples may correspond to a mini-batch. Processing module 542 may process the mini-batch by applying an operation to each component tuple in the mini-batch, thus generating output tuples. The output tuples may be sent to target task nodes via messages by sending module 545. In some cases, multiple output tuples may be batched into a single message by batching module 544. This batching may be independent of any previous batching.

At 140, a failure-recovery checkpoint may be generated by checkpointing module 543 after processing of the plurality of component tuples. This checkpoint serves as an intra-batch checkpoint, to preserve the current state of the task node 540. For example, an intra-batch checkpoint can be generated after processing of each mini-batch.

A failure-recovery checkpoint may be generated by storing identifiers associated with the message and the component tuples that have been processed since any previous failure-recovery checkpoints. If this is the first mini-batch of component tuples to be processed from the message, then there will not be any previous failure-recovery checkpoints. Additionally, computation results and output tuples generated during processing of the current mini-batch of component tuples may also be stored as part of the failure-recovery checkpoint. All this information may be stored in a database, such as checkpoint store 520. The checkpoint store 520 may be stored in a different computer than the task node 540 so that the stored data is not lost in the event of a failure of task node 540.

At 150, it may be determined whether there are more component tuples to be processed from the batch of tuples. For example, it may be determined whether any unprocessed mini-batches remain. If there are more tuples to be processed, method 100 may proceed to block 130 to begin processing the next mini-batch. If there are no more tuples to be processed, method 100 may end. In practice, in the context of a continuous streaming process, another message can be retrieved from input queue 510 and method 100 may begin anew at block 110.

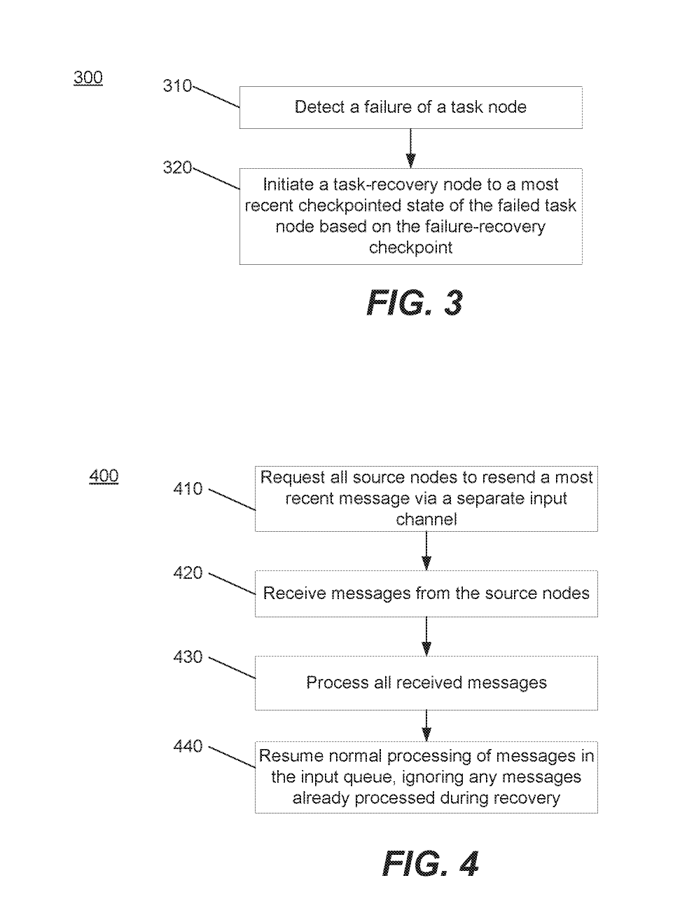

FIG. 3 illustrates a method of recovering from a failure, according to an example. Method 300 may begin at 310, where a failure of a task node, such as task node 540, can be detected. The failure may be detected by processing system 500. At 320, a task-recovery node may be initiated by failure recovery module 530. The task-recovery node may be instantiated on the same computer as the failed node was instantiated on, or on a different computer. The task-recovery node may include all of the modules associated with task node 540, and may be initiated to a most recent checkpointed state of the failed task node based on the failure-recovery checkpoint stored in checkpoint store 520, as described in more detail with respect to FIG. 4.

Method 400 may begin at 410, where task-recovery node may request all source nodes to resend a most recent message. Task-recovery node may send the request via a separate messaging channel distinct from the normal messaging channel used to send messages. For example, the separate messaging channel may be distinct from the messaging channel leading to input queue 510.

Task-recovery node may have access to an input-map corresponding to the task instance in the graph-structure of the streaming process. The input-map may include the identifiers of the messages previously processed by the failed task node. The task-recovery node may thus send a message to all of its source nodes identifying the last processed message according to the input-map and requesting the next message. In response, the source nodes may resend the next corresponding message. At 420, the task-recovery node may receive the messages from the source nodes.

At 430, the received messages may be processed by task-recovery node. This processing occurs before task-recovery node requests any messages from input queue 510. Each message may be processed according to method 100, except that the checkpoint store 520 may be accessed to determine whether a failure-recovery checkpoint exists for the message being processed. Where a failure-recovery checkpoint exists, an unpacked batch of tuples from the message may be processed beginning with at the checkpointed state. For example, if the message included a fat-tuple representing 1000 tuples, and the most recent failure-recovery checkpoint contained identifiers, computation results, and output tuples up to the 900^{th} component tuple, processing may begin at the 901^{st} component tuple. Before beginning processing at the 901^{st} component tuple, however, the state of the task-recovery node may be restored to the failed task node's state based on the checkpointed computation results, and the checkpointed output tuples may be resent (and rebatched) to target task nodes.

After processing of the messages received via the separate input channel, method 400 may proceed to 440 to resume normal processing of messages from input queue 510 according to method 100. Any messages in input queue 510 that are duplicates of the received messages that were just processed may be discarded and ignored (i.e., not processed again).

FIG. 6 illustrates a computing system for failure recovery in batch-based stream processing, according to an example. Computing system 600 may include and/or be implemented by one or more computers. For example, the computers may be server computers, workstation computers, desktop computers, laptops, mobile devices, or the like, and may be part of a distributed system. The computers may include one or more controllers and one or more machine-readable storage media, as described with respect to processing system 500, for example.

In addition, users of computing system 600 may interact with computing system 600 through one or more other computers, which may or may not be considered part of computing system 600. As an example, a user may interact with system 600 via a computer application residing on system 600 or on another computer, such as a desktop computer, workstation computer, tablet computer, or the like. The computer application can include a user interface (e.g., touch interface, mouse, keyboard, gesture input device).

Computing system 600 may perform methods 100-400, and variations thereof, and components 610-640 may be configured to perform various portions of methods 100-400, and variations thereof. Additionally, the functionality implemented by components 610-640 may be part of a larger software platform, system, application, or the like. For example, these components may be part of a data analysis system.

Computers 610 may have access to database 640. The database may include one or more computers, and may include one or more controllers and machine-readable storage mediums, as described herein. The computer may be connected to the database via a network. The network may be any type of communications network, including, but not limited to, wire-based networks (e.g., cable), wireless networks (e.g., cellular, satellite), cellular telecommunications network(s), and IP-based telecommunications network(s) (e.g., Voice over Internet Protocol networks). The network may also include traditional landline or a public switched telephone network (PSTN), or combinations of the foregoing.

Processor 620 may be at least one central processing unit (CPU), at least one semiconductor-based microprocessor, other hardware devices or processing elements suitable to retrieve and execute instructions stored in machine-readable storage medium 630, or combinations thereof. Processor 620 can include single or multiple cores on a chip, multiple cores across multiple chips, multiple cores across multiple devices, or combinations thereof. Processor 620 may fetch, decode, and execute instructions 632-638 among others, to implement various processing. As an alternative or in addition to retrieving and executing instructions, processor 620 may include at least one integrated circuit (IC), other control logic, other electronic circuits, or combinations thereof that include a number of electronic components for performing the functionality of instructions 632-638. Accordingly, processor 620 may be implemented across multiple processing units and instructions 632-638 may be implemented by different processing units in different areas of engine 610.

Machine-readable storage medium 630 may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium 630 can be computer-readable and non-transitory. Machine-readable storage medium 630 may be encoded with a series of executable instructions for managing processing elements.

The instructions 632-638 when executed by processor 620 (e.g., via one processing element or multiple processing elements of the processor) can cause processor 620 to perform processes, for example, methods 100-400, and/or variations and portions thereof.

Computers 610 may be part of a distributed stream processing system, as described above. The instructions 632-638 stored on storage medium 630 may be instructions executed by a task node in the stream processing system. For example, unpacking instructions 632 may cause processor 620 to unpack a fat-tuple into a batch of component tuples. The fat-tuple may be the payload of a message received from a source node. Mini-batch instructions 634 may cause processor 620 to identify mini-batch boundaries in the batch of component tuples. Processing instructions 636 may cause processor 620 to process the component tuples up to a mini-batch boundary. Checkpoint instructions 638 may cause processor 620 to generate a failure-recovery checkpoint at each mini-batch boundary. The failure-recovery checkpoint may represent a current processing state of the task node relative to the fat-tuple. The processing instructions 636 and checkpoint instructions 638 may continue to be executed in a loop until all of the component tuples have been processed. Afterward, subsequent messages may then be processed in a similar fashion.

Additional instructions may be stored and executed by computers 610 to recovery a task node that fails. In particular, in the event of a failure of a task node during processing of the batch of tuples, the instructions may cause computers 610 to initiate a second task node to the processing state of the failed task node. This can be done using the failure recovery checkpoint. The instructions may cause the second task node to process the remaining component tuples in the batch. For example, until all of the component tuples have been processed, the second task node may process the remaining component tuples up to a mini-batch boundary, and generate a failure-recovery checkpoint at each mini-batch boundary representing a current processing state of the second task node relative to the fat-tuple. The second task node may then process subsequent messages.

In the foregoing description, numerous details are set forth to provide an understanding of the subject matter disclosed herein. However, implementations may be practiced without some or all of these details. Other implementations may include modifications and variations from the details discussed above. It is intended that the appended claims cover such modifications and variations.

What is claimed is:

1. A method for failure recovery of a task state in batch-based stream processing, comprising, by a processor:
receiving a message comprising a batch of tuples; and
processing the message, comprising:
unpacking the batch of tuples into multiple component tuples;
processing, at a task node, a plurality of the component tuples, wherein the plurality of the component tuples is less than all of the component tuples; and
generating a failure-recovery checkpoint of a state of the task node after processing the plurality of the component tuples.

2. The method of claim 1, wherein processing the message further comprises:
dividing the component tuples into mini-batches; and
generating an intra-batch failure-recovery checkpoint of a state of the task node after the task node processes each mini-batch.

3. The method of claim 1, wherein generating a failure-recovery checkpoint comprises:
storing identifiers associated with the message and the component tuples that have been processed since a most recent failure-recovery checkpoint; and
storing computation results and output tuples generated during the processing of the component tuples that have been processed since a most recent failure-recovery checkpoint.

4. The method of claim 1, further comprising:
if the task node fails during processing of the message, initiating a task-recovery node to a most recent checkpointed state of the failed task node based on the failure-recovery checkpoint.

5. The method of claim 4, further comprising, in the event of the failure of the task node during processing of the message:
requesting, via a separate messaging channel, all source nodes to resend a most recent message based on an input-map;
receiving, via the separate messaging channel, messages from the source nodes in response to the request;
processing, at the task-recovery node, the received messages starting at the most recent checkpointed state.

6. The method of claim 1, wherein processing the message further comprises:
sending generated output tuples to target nodes, wherein a subset of the output tuples are packed into a payload of an emitted message as a batch.

7. The method of claim 1, wherein the batch of tuples is arranged in the message as a fat-tuple comprising key fields and a nested relation that depends on the key fields.

8. A system for failure recovery of a task state in batch-based stream processing, comprising:
an input queue storing a plurality of messages received from one or more source nodes;
a task node to process the messages in the input queue, the task node comprising:
a batch-unpacking module to unpack a fat-tuple in one of the plurality of messages into component tuples;
a processing module to process the component tuples by applying an operation to each component tuple to generate a respective output tuple;
a failure-recovery checkpoint module to generate a failure recovery checkpoint of a state of the task node, wherein the failure-recovery checkpoint is configured to generate at least one failure-recovery checkpoint before all of the component tuples have been processed by the processing module.

9. The system of claim 8, further comprising:
a checkpoint store to store failure-recovery checkpoints generated by the failure-recovery checkpoint module,
each failure-recovery checkpoint including identification information of processed component tuples, computation information, and generated output tuples.

10. The system of claim 9, further comprising:
a failure recovery module to initiate a new task node if the task node fails during processing of a message, the new task node being initiated to a most recently checkpointed state of the failed task node based on a most recent failure recovery checkpoint stored in the checkpoint store.

11. The system of claim 10, wherein the new task node is configured to:
request, via a messaging channel separate from a messaging channel for the input queue, a most recent message from all of the new task node's source nodes based on an input-map;
receive messages from the source nodes in response to the request;
processing the received messages beginning at the most recently checkpointed state.

12. The system of claim 8, wherein the task node further comprises:
a batching module to store output tuples into a fat-tuple; and
a sending module to send a message comprising the fat-tuple to a target node.

13. The system of claim 8, wherein the failure-recovery checkpoint module is configured to:
identify mini-batch boundaries between a plurality of the component tuples; and
generate a failure-recovery checkpoint at each mini-batch boundary.

14. A non-transitory computer-readable storage medium storing instructions for execution by a computer for failure recovery of a task state in batch-based stream processing, the instructions when executed causing a computer to:
unpack a fat-tuple into a batch of component tuples;
identify mini-batch boundaries in the batch of component tuples; and
until all of the component tuples have been processed:
process, at a task node, the component tuples up to a mini-batch boundary; and
generate a failure-recovery checkpoint at each mini-batch boundary representing a current processing state of the task node relative to the fat-tuple.

15. The computer-readable storage medium of claim 14, wherein the fat-tuple constitutes the payload of a received message.

16. The computer-readable storage medium of claim 14, the instructions when executed further causing the computer to:
in the event of a failure of the task node, initialize a second task node to the processing state of the failed task node; and
until all of the component tuples have been processed:
process, at the second task node, the component tuples up to a mini-batch boundary; and
generate a failure-recovery checkpoint at each mini-batch boundary representing a current processing state of the second task node relative to the fat-tuple.
